(19) United States
(12) Patent Application Publication
(10) Pub. No.: US 2012/0288740 A1
(43) Pub. Date: Nov. 15, 2012

(54) BATTERY PACK

(76) Inventors: Jeong-Deok BYUN, Yongin-si (KR); Eun-Ok KWAK, Yongin-si (KR); Jong-Wook YOON, Yongin-si (KR); Byoung-Ju KIM, Yongin-si (KR)

(21) Appl. No.: 13/344,799

(22) Filed: Jan. 6, 2012

(30) Foreign Application Priority Data
May 12, 2011 (KR) 10-2011-0044673

(51) Int. Cl. H01M 2/10; H01M 2/30

(52) U.S. Cl. 429/96

(57) ABSTRACT

A battery pack includes a battery unit including a battery cell, and a lead tap extending from the battery cell, a frame case that supports the battery unit, the frame case including a first supporting portion for supporting the battery cell and a second supporting portion for supporting the lead tap; and a holder case on the second supporting portion with the lead tap interposed between the holder case and the second supporting portion.

### BACKGROUND

1. Field

One or more embodiments relate to a battery pack.

2. Description of the Related Art

Secondary batteries are used in various technical fields due to their advantages. For example, they are used as an energy source for mobile electric devices, such as digital cameras, cellular phones, or notebook computers, and also, as an energy source for hybrid electric vehicles that are presented as a solution for preventing atmospheric pollution caused by conventional gasoline and diesel internal combustion engines using fossil fuels. The secondary batteries may be housed in a pack case and thus packaged, or may be provided in the form of a battery pack.

### SUMMARY

According to an embodiment, there is provided a battery pack including a battery unit including a battery cell, and a lead tap extending from the battery cell, a frame case that supports the battery unit, the frame case including a first supporting portion for supporting the battery cell and a second supporting portion for supporting the lead tap, and a holder case on the second supporting portion with the lead tap interposed between the holder case and the second supporting portion.

The lead tap may include a pair of first and second lead taps. The holder case may include a pair of first and second holder cases that respectively overlap the first and second lead taps on first and second sides of the second supporting portion.

The first and second holder cases may include a misalignment prevention structure for preventing incorrect assembling of one of the first and second holder cases into an assembly position of another one of the first and second holder cases.

A shape of the first holder case may be asymmetric to a shape of the second holder case such that the first holder case is prevented from being assembled in an assembly position of the second holder case.

The first holder case may have a protrusion such that the first holder case is prevented from being assembled in an assembly position of the second holder case.

The second supporting portion may include first and second assembly regions having shapes that respectively correctly fit the first and second holder cases.

The first assembly region may include a protrusion housing portion for housing the protrusion of the first holder case.

The second assembly region may include a coupling interruption portion for preventing coupling with the protrusion of the first holder case.

The first supporting portion may include a main body for supporting a main surface of the battery cell, and first and second ribs that are bent from the main body at opposite lateral sides of the main body and extend in parallel along side surfaces of the battery cell.

First and second spacers may be respectively located at ends of the first and second ribs in asymmetric positions in an extension direction of the first and second ribs.

The holder case may include a pair of first and second holder cases. An inner edge of each of the first and second holder cases may include a wide protrusion. An outer edge of each of the first and second holder cases may include a narrow protrusion. The inner edges may be adjacent to each other. The outer edges may be located away from each other. The wide and narrow protrusions may have different widths.

The second supporting portion may include a wide housing portion that receives the combined wide protrusions of the first and second holder cases, and narrow housing portions that respectively receive the narrow protrusions of the first and second holder cases.

A terminal member may be coupled to the second supporting portion as one piece, and the lead tap may be disposed on the terminal member.

According to another embodiment, there is provided a battery pack including a battery unit including a battery cell and first and second lead taps extending from the battery cell, a frame case that supports the battery unit and includes a first supporting portion for supporting the battery cell and a second supporting portion for supporting the first and second lead taps, and first and second holder cases on the second supporting portion with the first and second lead taps interposed between the first and second holder cases, respectively, and the second supporting portion. A shape of the first holder case is asymmetric to a shape of the second holder case.

The first holder case may have a protrusion protruding from a side surface thereof.

The second supporting portion may include first and second assembly regions having shapes that respectively fit the first and second holder cases. A protrusion housing portion for housing the protrusion may be formed in the first assembly region.

The second assembly region may include a coupling interruption portion for interrupting coupling with the protrusion.

A terminal member may be coupled to the second supporting portion. The first and second lead taps may be disposed on the terminal member as one piece.

The first supporting portion may include a main body for supporting a main surface of the battery cell, and first and second ribs that are bent from the main body at opposite lateral sides of the main body and extend in parallel along side surfaces of the battery cell.

First and second spacers may be respectively located at ends of the first and second ribs in asymmetric positions in an extension direction of the first and second ribs.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a battery pack according to an embodiment;

FIG. 2 illustrates a cross-sectional view taken along a line II-II of FIG. 1;

FIG. 3 illustrates a view to explain a misalignment prevention structure of the battery pack of FIG. 1;

FIG. 4 illustrates a detailed perspective view of the holder case shown in FIG. 1;

FIG. 5 illustrates a view to explain a misalignment prevention structure of a holder case; and

FIGS. 6 and 7 illustrate views to explain another misalignment prevention structure of the holder case.

### DETAILED DESCRIPTION

Korean Patent Application No. 10-2011-0044673, filed on May 12, 2011, in the Korean Intellectual Property Office, and entitled: “Battery Pack,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of regions may be exaggerated for clarity of illustration. Like reference numerals refer to like elements throughout. Teens such as “up,” “down,” “left,” and “right” may be understood with respect to the coordinate legend provided in the drawing. In particular, “down” may refer to a direction toward a side in which the first supporting portion 151 of the case frame 150, described below, is disposed, and “up” may refer to an opposite direction. The terms “left” and “right” may be understood with reference to the battery pack being oriented such that the second supporting portion 152 of the case frame 150 is in a direction away from a viewer. It is to be understood that the embodiments are not limited to the described orientation of “left” and “right.”

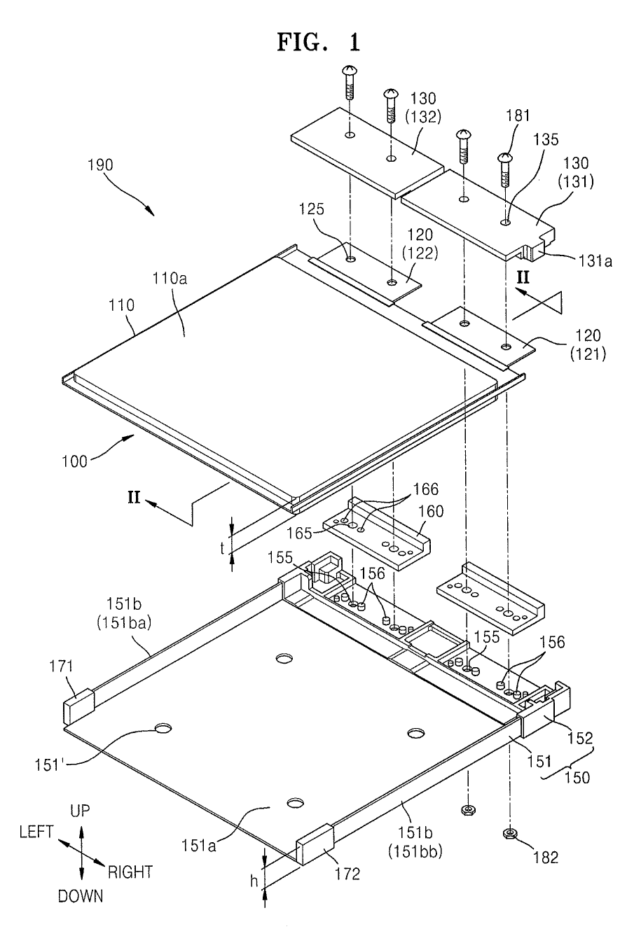

Hereinafter, a battery pack according to an exemplary embodiment will be described in detail with reference to the attached drawings. FIG. 1 is an exploded perspective view of a battery pack 190 according to an embodiment. Referring to FIG. 1, the battery pack 190 includes a battery unit 100, and a case frame 150 for housing the battery unit 100.

The battery unit 100 may include a rechargeable secondary battery, for example, a lithium-ion battery. The battery unit 100 includes a battery cell 110, and a lead tap 120 that is electrically connected to the battery cell 110 and extends from the battery cell 110.

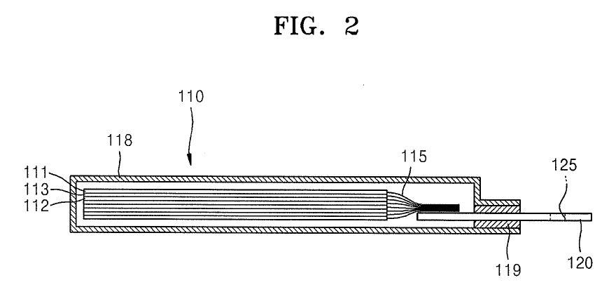

FIG. 2 is a cross-sectional view taken along a line II-II of FIG. 1. Referring to FIG. 2, the battery cell 110 may include, for example, an electrode assembly formed by sequentially stacking a positive electrode plate 111, a separator 113, and an negative electrode plate 112. To manufacture a high output and high capacity battery pack, a plurality of the positive electrode plates 111, the separators 113, and the anode plates 112 may be stacked. The electrode assembly stack in which the positive electrode plate 111 and the negative electrode plate 112 are stacked with the separator 113 interposed therebetween is sealed in a pouch 118.

Although not illustrated in FIG. 2, the positive electrode plate 111 may be formed by applying a positive active material on a surface of a positive current collector, and the negative electrode plate 112 may be formed by applying a negative active material on a surface of a negative current collector.

Each of the positive electrode plate 111 and the negative electrode plate 112 may be electrically connected to an electrode tap 115. The electrode taps 115 extending from the positive electrode plate 111 and the negative electrode plate 112 are stacked on each other and overlap each other, and the densely aligned electrode taps 115 may be electrically connected to the lead tap 120. The electrode taps 115 and the lead tap 120 may be connected by, for example, ultrasonic fusing.

The lead tap 120 may form an external interconnection of the battery cell 110, and may extend from the battery cell 110 so as to induce a current from the battery cell 110 to the outside. For example, a portion of the lead tap 120 may extend to the outside of the pouch 118. To secure insulating properties, an insulating member 119 may be disposed between the lead tap 120 and the pouch 118.

The lead tap 120 may include a highly conductive metallic material, such as nickel, aluminum, or copper. Referring to FIG. 1, the lead tap 120 may include first and second lead taps 121 and 122 having different polarities. The first and second lead taps 121 and 122 may be respectively electrically connected to the positive electrode plate 111 and negative electrode plate 112 of the battery cell 110.

The battery cell 110 may be electrically connected to an external load or an external power supply device via the lead tap 120. The battery cell 110 may output charge and discharge currents to an external load via the lead tap 120, or may receive charge and discharge currents from an external power supply device via the lead tap 120.

The lead tap 120 may have a connection hole 125 for electric connection with a terminal member 160. The connection hole 125 may be spaced apart from an edge of the lead tap 120 at a predetermined interval. The connection hole 125 may be spaced apart from facing edges of the lead tap 120.

The battery unit 100 is disposed on the case frame 150, and supported by the case frame 150. The battery unit 100 may be disposed on the case frame 150 in such a way that the battery unit 100 faces the case frame 150.

The case frame 150 includes a first supporting portion 151 for housing and supporting the battery cell 110, and a second supporting portion 152 for housing and supporting the lead tap 120 extending from the battery cell 110.

The case frame 150 may protect the battery unit 100 from external impacts, and may also function as a heat dissipating plate for emitting heat, generated when the battery unit 100 is charged and discharged, to the outside. To protect the battery from impacts and to dissipate heat, the first supporting portion 151 may include a metallic material that has mechanical strength and high thermal conductivity. For example, the first supporting portion may include aluminum.

The first supporting portion 151 may have a thermal contact with the battery cell 110, and may emit heat generated during charging and discharging to the outside via the first supporting portion 151. An electrical insulating layer (not shown) may be formed along an outer surface of the first supporting portion 151 so as to insulate the battery cell 110 from surrounding environments.

For example, the first supporting portion 151 may be formed of an aluminum material, and an oxide film may be formed on the outer surface of the first supporting portion 151. The oxide film may be formed through an oxidation process, such as an anodizing treatment, thereby insulating the first supporting portion 151. The first supporting portion 151 may be structured in such a way that heat dissipation is expedited by having a thermal contact of the first supporting portion 151 with the battery cell 110. An electrical insulation of the battery cell 110 may maintained so as to not interrupt charging and discharging operations of the battery cell 110.

The first supporting portion 151 may have an overall planar shape, and a rib 151b may be formed perpendicular to the first supporting portion 151 at opposite side portions of the first supporting portion 151 so as to partially surround the battery cell 110. In detail, the first supporting portion 151 may include a main body 151a that is planar, and the rib 151b, which is disposed like a wing on opposite sides of the main body 151a. The rib 151b may be perpendicular to the main body 151a and may be integrally formed with the main body 151a. For example, the main body 151a of the first supporting portion 151 supports a main surface of the battery cell 110, that is, a lower surface of the battery cell 100, and the rib 151b may extend along a side surface of the battery cell 110, covering the side surface of the battery cell 110. The rib 151b may include first and second ribs 151ba and 151bb covering facing side surfaces of the battery cell 110. The first and second ribs 151ba and 151bb may extend in parallel to each other along the side surfaces of the battery cell 110. That is, the first supporting portion 151 partially surrounds the battery cell 110 to protect the battery cell 110, which has relatively small rigidity, and to insulate the battery cell 110 from the outside.

Spacers 171 and 172 may be formed on the rib 151b. The spacers 171 and 172 may be integrally formed with the case frame 150 when the case frame 150 is formed by injection molding. The spacers 171 and 172 may be formed of an insulating resin, for example, a polymer resin such as PPS. An injection molding product of the polymer resin may form the spacers 171 and 172. The spacers 171 and 172 may be molded together with the first supporting portion 151 of the case frame 150. For example, injection molding using different materials may be performed to produce a case frame 150 including a first supporting portion 151 formed of a metal material and spacers 171 and 172 formed of a resin material.

The spacers 171 and 172 may provide a space between battery packs 190 that are next to each other in a stack direction in a module structure (not shown) in which a plurality of the battery packs of FIG. 1 are electrically connected. For example, heights (h) of the spacers 171 and 172 may each be greater than a thickness t of each battery cell 110.

In detail, to manufacture a battery module with high output and high capacity, the battery cell 110 supported by the case frame 150 may be used as a unit and a plurality of the battery cells 110 may be stacked laterally and electrically connected in series or parallel to form a battery module. In this case, due to the first and second spacers 171 and 172 surrounding the battery cell 110, the stacked battery cells 110 are spaced from each other at predetermined intervals, and battery cells 110 that are next to each other in the stack direction may be spaced apart from each other. Due to the spaces among the battery cells 110, swelling of the battery cells 110 that may occur during discharging 110 may be tolerated, and heat generated from the battery cell 110 may be emitted through the spaces, thereby expediting heat dissipation of the battery cell 110.

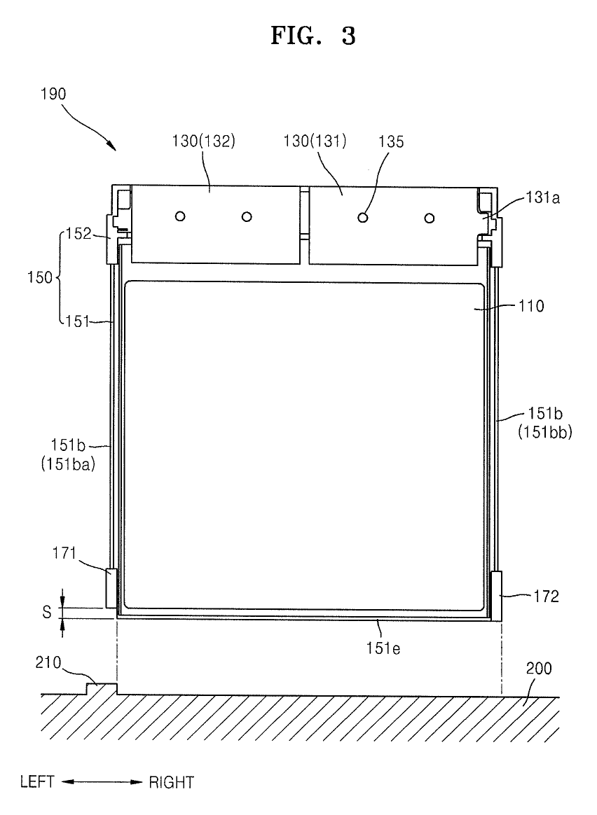

FIG. 3 is a view to explain assembling of the battery pack 190 of FIG. 1 on a tray 200 and to explain a misalignment prevention structure of the battery pack 190 when the battery pack 190 of FIG. 1 is assembled on a tray 200 in a standing state.

Referring to FIG. 3, the spacers 171 and 172 may contribute to prevention of laterally incorrect insertion by fitting with a reverse insertion prevention structure 210 on the tray 200 when battery packs 190 are housed and placed on the tray 200. As illustrated in FIG. 3, the spacers 171 and 172 may include first and second spacers 171 and 172 at ends of the first and second ribs 151ba and 151bb extending along the side surfaces of the battery cell 110.

In this regard, locations of the first and second spacers 171 and 172 may be asymmetric to each other. For example, locations of the first and second spacers 171 and 172 may be asymmetric to each other along a direction in which the rib 151b extends.

In detail, with respect to an exposed edge 151e of the battery pack 190, the first spacer 171 may be formed spaced apart from the exposed edge 151e at an interval S, and the second spacer 172 may be formed substantially contacting the exposed edge 151e. Due to the first spacer 171, a left side of the battery pack 190 has an indentation, and due to the second spacer 172, a right side of the battery pack 190 has a planar shape. The first and second spacers 171 and 172 located asymmetrically may form a misalignment prevention structure.

In addition to the laterally asymmetric misalignment prevention structure with respect to the exposed edge 151e of the battery pack 190, the reverse insertion prevention structure 210 that fits the misalignment prevention structure is formed on a surface of the tray 200 contacting the exposed edge 151e of the battery pack 190, thereby enabling detection of any lateral misalignment of the battery pack 190.

The reverse insertion prevention structure 210 that fits in shape with the misalignment prevention structure may be formed on a surface of the tray 200 that houses the battery pack 190, that is, on a surface of the tray 200 that houses and contacts the exposed edge 151e of the battery pack 190.

In detail, the reverse insertion prevention structure 210 having a protrusion shape that fits the indented misalignment prevention portion of the battery pack 190 may be formed on a left side of the tray 200, and a right side of the tray 200 may have a planar structure. Thus, when the battery pack 190 is laterally reversely mounted on the tray 200, the misalignment prevention structure of the battery pack 190 does not fit the reverse insertion prevention structure 210 of the tray 200 and thus, the battery pack 190 comes off the tray 200. Thus, an operator may notice the lateral misalignment assembly and change an orientation of the battery pack 190.

For example, to manufacture a battery module with high output and high capacity, a plurality of battery packs 190 are placed on the tray 200 and stacked in parallel to each other, and then, the battery packs 190 are electrically connected in series or parallel via a bus bar (not shown). For example, the bus bar may extend above battery packs 190 that stand and are stacked in parallel, and may respectively electrically connect positive and negative terminals of one battery pack to positive and negative terminals of a neighboring battery pack thereof. In this case, if the battery pack 190 is assembled in a laterally reverse state, polarity of neighboring battery packs 190 may be non-uniform, which may lead to incorrect polarity connection among battery packs 190. According to an embodiment, the lateral misalignment assembly of the battery pack 190 is prevented so that positive terminals and negative terminals of battery packs 190 are correctly aligned with respect to each other, thereby embodying stable series connection and parallel connection.

Meanwhile, referring to FIG. 1, the first supporting portion 151 may have a vent hole 151′ to provide heat dissipation. Through the vent hole 151′, heat of the battery cell 110 may be emitted to the outside, or low temperature air may flow thereinto. Thus, heat generated when the battery cell 110 is charged and discharged may be dissipated.

The first supporting portion 151 may be exposed to the outside. A top surface 110a of the battery cell 110 housed on the first supporting portion 151 may be exposed to the outside and heat generated from the battery cell 110 may be emitted directly toward the outside. The main body 151a of the first supporting portion 151 supports the battery cell 110 via a lower surface of the battery cell 110, the rib 151b of the first supporting portion 151 covers and protects the side surface of the battery cell 110 by covering. The top surface 110a of the battery cell 110 is exposed to the outside.

The second supporting portion 152 houses the lead tap 120 that extends from the battery cell 110. The second supporting portion 152 may house the lead tap 120 with a terminal member 160 interposed therebetween, and the lead tap 120 may be placed on the terminal member 160. For example, a coupling member 181 may be coupled to the terminal member 160 via the lead tap 120. Accordingly, the lead tap 120 and the terminal member 160 may be coupled to each other. The terminal member 160 may have a connection hole 165 to allow the coupling member 181 to be coupled thereto, and the connection hole 165 may be located corresponding to the connection hole 125 of the lead tap 120. The second supporting portion 152 may have a connection hole 155 to allow the coupling member 181 to pass through, and the connection hole 155 may be located corresponding to the connection holes 125 and 165 of the lead tap 120 and the terminal member 160.

The second supporting portion 152 may be formed of an insulating material so as to insulate the terminal member 160 from surrounding environments and to prevent electrical shorting. For example, the second supporting portion 152 may be formed of a polymer resin, such as PPS. An injection molding product of a polymer resin may be used as the second supporting portion 152.

The terminal member 160 may be assembled on the second supporting portion 152. For example, the terminal member 160 may be fixed on the second supporting portion 152. Regarding assembling of the terminal member 160 and the second supporting portion 152, the terminal member 160 may be coupled to the second supporting portion 152 as one body, for example, integrally coupled. For example, the terminal member 160 may be integrally formed with the second supporting portion 152 when the second supporting portion 152 is molded. In detail, the second supporting portion 152 may be formed by injection molding, and when the second supporting portion 152 is formed by injection molding, the terminal member 160 may be disposed inside an injection molding frame (not shown) and raw material paste (not shown) may be injected thereinto, thereby forming the terminal member 160 and the second supporting portion 152 as one body when the paste is hardened.

The terminal member 160 may have a fixing hole 166 for coupling to the second supporting portion 152. For example, a fixing protrusion 156 protruding from the second supporting portion 152 may be inserted into the fixing hole 166 of the terminal member 160, thereby forming the terminal member 160 and the second supporting portion 152 as one body. The fixing protrusion 156 may be formed by injecting a raw material paste into the fixing hole 166 of the terminal member 160 when the second supporting portion 152 is formed by injection molding.

The fixing hole 166 of the terminal member 160 may be formed near the connection hole 165, and if desired, two or more fixing holes may be formed. For example, as illustrated in FIG. 1, a pair of fixing holes 166 may be formed on opposite sides of each connection hole 165. The fixing protrusion 156 may be formed on the second supporting portion 152, corresponding to the fixing hole 166. A pair of fixing protrusions 156 may be formed on opposite sides of the connection hole 155.

The terminal member 160 may be electrically connected to the lead tap 120, and may mediate flow of charge and discharge currents between outside and inside the case frame 150. For example, a current generated from the battery cell 110 may flow out to the outside of the battery pack 190 via the lead tap 120 and the terminal member 160.

The terminal member 160 may surface-contact the lead tap 120 in an overlapping state. The terminal member 160 and the lead tap 120 may be closely attached to each other by the coupling member 181 passing through the connection holes 125 and 165 formed at locations corresponding to each other in the terminal member 160 and the lead tap 120. The coupling member 181 may pass through the lead tap 120 and the terminal member 160, thereby coupling together the lead tap 120, the terminal member 160, and the second supporting portion 152.

The terminal member 160 may be formed of a metallic material having excellent electrical conductivity properties, such as nickel, copper, or aluminum, and may be formed as a rectangular metallic block. For example, the terminal member 160 may be formed as a nickel-plated copper block.

The terminal member 160 may have the connection hole 165 for connection with the lead tap 120. The connection hole 165 of the terminal member 160 may be formed corresponding to the connection hole 125. Regarding coupling of the terminal member 160 and the lead tap 120, for example, the terminal member 160 and the lead tap 120 may be disposed to overlap each other and then, the coupling member 181 may be inserted into the connection holes 125 and 165 formed at locations corresponding to each other in the terminal member 160 and the lead tap 120, thereby coupling the terminal member 160 and the lead tap 120.

The coupling of the terminal member 160 and the lead tap 120 may be performed simultaneously with coupling of the case frame 150 and the battery unit 100. That is, the case frame 150 may be disposed facing the battery unit 100 in such a way that the first supporting portion 151 faces the battery cell 110 and the second supporting portion 152 faces the lead tap 120.

The second supporting portion 152 is disposed facing the lead tap 120 with the terminal member 160 interposed therebetween. For example, the terminal member 160 may be fixed to the second supporting portion 152 in advance and in this state, the terminal member 160 may be disposed facing the lead tap 120. Then, the coupling member 181 may be assembled to pass through the terminal member 160, and the lead tap 120 which are disposed overlapping, thereby coupling the terminal member 160 and the lead tap 120. The coupling member 181 that couples the terminal member 160 and the lead tap 120 may be coupled with, for example, another coupling member 182 by passing through the second supporting portion 152 of the case frame 150. Thus, the battery unit 100 may be coupled to the case frame 150.

Through the coupling of the terminal member 160 and the lead tap 120, the case frame 150 on which the terminal member 160 is fixed may be simultaneously coupled with the battery unit 100 on which the lead tap 120 is fixed. However, the present invention is not limited to the exemplary embodiment. For example, a separate coupling structure may be provided to couple the case frame 150 to the battery unit 100.

As the coupling members 181 and 182, any one of various coupling structures that may be passed through and inserted into the connection holes 125 and 165 of the terminal member 160 and the lead tap 120 may be used. For example, a bolt-nut assembly may be used. Regarding middle and large-sized batteries with a high capacity and high output, a thickness of a connection portion including the terminal member 160 and the lead tap 120 may need to be increased, and accordingly, a mechanical coupling using the coupling members 181 and 182 may be more appropriate than coupling performed by thermal fusing. The coupling performed by thermal fusing may require a high-output heat source, and may provide insufficient coupling strength and non-uniform coupling, and also, a coupling thickness obtainable thereby may be limited. Accordingly, the coupling members 181 and 182 may not be limited to the nut-bolt assembly illustrated in FIG. 1 as long as the lead tap 120 is mechanically coupled to the terminal member 160.

A surface of the lead tap 120, for example, the lower surface, may surface-contact the terminal member 160. Due to a coupling pressure of the coupling members 181 and 182, the lead tap 120 may forcibly and closely contact the terminal member 160. In this regard, another surface of the lead tap 120, for example, the top surface, may contact a holder case 130.

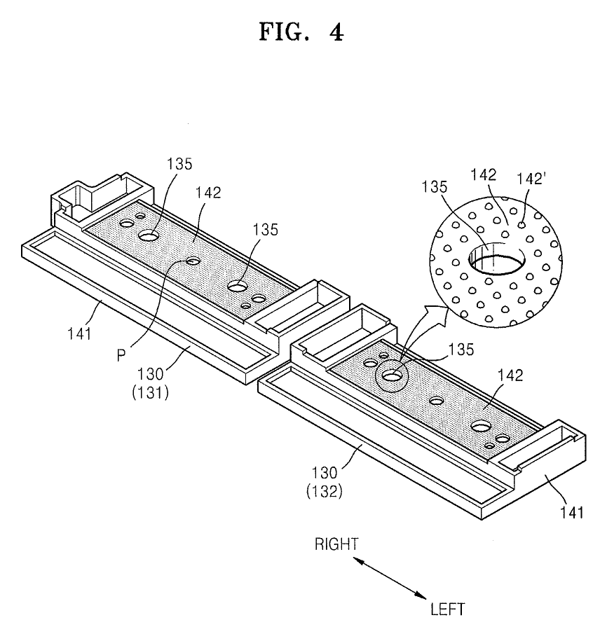

FIG. 4 is a detailed perspective view of the holder case 130, in particular, a lower surface of the holder case 130. Referring to FIG. 4, the holder case 130 may prevent exposure of an electrically conductive member, for example, the lead tap 120 and the terminal member 160, to the outside. The holder case 130 may insulate an electrically conductive member from surrounding environments so as to prevent exposure of the electrically conductive member to the outside, and thus, an electrical interruption caused by surrounding environments may be blocked. To prevent such exposure, an outer portion of the holder case 130 may be formed of an insulating material. For example, a cover 141 that forms the outer portion of the holder case 130 may be formed of an insulating resin material.

Also, the holder case 130 may enhance an electrical connection state of the connection portion including the terminal member 160 and the lead tap 120 to reduce an electrical resistance of the connection portion, and ultimately, to improve charge and discharge efficiency. For example, the holder case 130 may provide a uniform surface pressure to the lead tap 120 that is transmitted to the terminal member 160. A coupling force between the lead tap 120 and the terminal member 160 may be increased. For example, the lead tap 120 may be sandwiched between the terminal member 160 and the holder case 130, and may form a strong electrical connection with the terminal member 160 and the holder case 130.

The holder case 130 may additionally include an electrically conductive region so as to reduce an electrical resistance of charge and discharge currents. To provide such decreased electrical resistance, an inner portion of the holder case 130 that surface-contacts the electrode tap 120 may be formed of a conductive plate 142, which may be formed of a highly conductive metallic material.

According to an embodiment, the lead tap 120 extending from the battery cell 110 may be interposed between the terminal member 160 and the holder case 130, and the terminal member 160 and the holder case 130 may be pressed in facing directions due to a coupling pressure of the coupling members 181 and 182, thereby forming a sandwich structure in which the lead tap 120 is interposed between the terminal member 160 and the holder case 130 and contacts the terminal member 160 and the holder case 130.

The lead tap 120 may be a place where a discharge current from the battery cell 110 or a charge current from an external power source device (not shown) is focused, for example, in the battery pack 110 with high output and high capacity, a high charge and discharge current is focused and an electrical resistance is increased in the lead tap 120, thereby generating heat. In an embodiment, the terminal member 160 and the holder case 130, which are electrically conductive, may be disposed on opposite sides of the lead tap 120 so as to widen an electrically conductive region of charge and discharge currents and reduce an electrical resistance of charge and discharge currents.

Also, according to an embodiment, the terminal member 160 and the holder case 130, which are thermally conductive, may be disposed on opposite sides of the lead tap 120 so as to widen a heat dissipation region of the connection portion of the battery pack 190 that includes the lead tap 120, and improve a heat dissipation property. For example, the connection portion of the battery pack 190 may function as an interface of the battery pack 190 that mediates an output of a discharge current from the battery pack 190 or an input of a charge current from external power source device.

According to an embodiment, a mechanical coupling state of the connection portion of the battery pack 190 may be enhanced by pressing the terminal member 160 and the holder case 130, disposed on opposite sides of the lead tap 120, in facing directions via the coupling pressure of the coupling members 181 and 182. For example, in the battery pack 190 with high output and high capacity, a coupling strength thereof may be decreased due to the weight thereof. However, according to an embodiment, the terminal member 160 and the holder case 130 disposed on opposite sides of the lead tap 120, forming a sandwich structure, may apply pressure to each other by using the coupling members 181 and 182. Thus, the mechanical coupling state of the connection portion of the battery pack 190 may be enhanced.

The holder case 130 may have a planar shape, and may include the connection hole 135 for allowing the coupling member 181 to pass therethrough. The connection hole 135 of the holder case 130 may be formed corresponding to the connection hole 125 of the lead tap 120. The coupling member 181 for coupling the terminal member 160 and the lead tap 120 may be inserted into the holder case 130 by passing through the connection hole 135, and by the coupling member 181, the terminal member 160, the lead tap 120, and the holder case 160 may be coupled together. The coupling member 181 may simultaneously couple the holder case 130, the lead tap 120, and the terminal member 160 by passing therethrough. Accordingly, the assembling process of the battery pack 190 may be simplified.

The holder case 130 may include the conductive plate 142 contacting the lead tap 120, and the cover 141 housing the conductive plate 142. The conductive plate 142 may overall have a planar shape, and may form a contact surface facing the lead tap 120.

As illustrated in FIG. 4, the contact surface of the conductive plate 142 may have a surface roughness formed by dispersing a plurality of protrusions 142′. An embossing treatment may enable the formation of protrusions 142′ at the contact surface. The protrusions 142′ may protrude from the conductive plate 142 toward the lead tap 120, and may contribute to a stronger electrical binding between the conductive plate 142 and the lead tap 120.

Due to the protrusions 142′, a contact region of the contact surface with respect to the lead tap 120 may be increased and thus a contact resistance between the contact surface and the lead tap 120 may be reduced. The protrusions 142′ may have a relatively small height, and may contact the lead tap 120 under pressure by the pressure coupling strength of the coupling members 181 and 182. If the protrusions 142′ are too large, the conductive plate 142 and the lead tap 120 may insufficiently surface-contact each other. Accordingly, the protrusions 142′ may be formed in a sufficiently small size that may be appropriate for forming a surface contact with the lead tap 120 by the pressure coupling strength.

The cover 141 and the conductive plate 142 may be formed as one body by, for example, injection molding using different materials. The cover 141 may be formed of an insulating resin material, for example, a polymer resin such as PPS, and an injection molding product may be used as the cover 141. During the injection molding, the conductive plate 142 may be disposed inside a molding frame (not shown) and a polymer resin paste (not shown) may be injected thereinto and hardened, thereby forming the holder case 130 including the conductive plate 142 formed of metal and the cover 141 formed of resin as illustrated in FIG. 4.

For a strong coupling between the cover 141 and the conductive plate 142, a fixing hole (not shown) may be formed in the conductive plate 142, and a fixing protrusion (not shown) that fills the fixing hole may be formed in the cover 141. The fixing protrusion filling the fixing hole may enable a strong coupling between the cover 141 and the conductive plate 142. In FIG. 4, reference character P exemplarily denotes a location where the fixing protrusion fills the fixing hole to couple the cover 141 with the conductive plate 142.

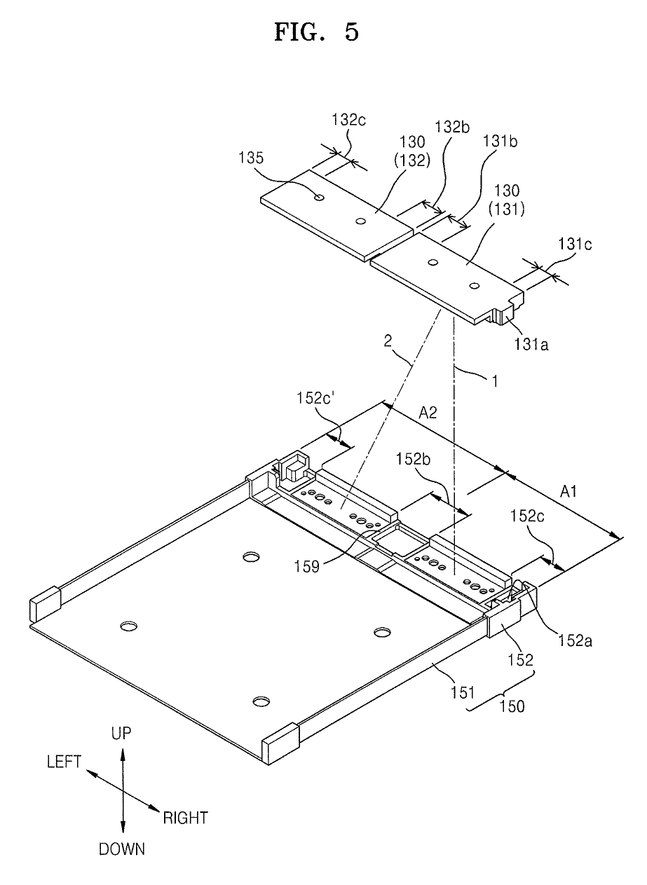

FIG. 5 is a view to explain the misalignment prevention structure of the holder case 130. Referring to FIG. 5, a pair of holder cases 130 may be formed on left and right sides of the frame case 150. For example, the holder case 130 may include the first and second holder cases 131 and 132 corresponding first and second lead taps 121 and 122. The first and second holder cases 131 and 132 may have similar shapes. However, to prevent reverse assembling of the first and second holder cases 131 and 132 due to confusion from their similar shapes, the first and second holder cases 131 and 132 may instead have different shapes. That is, the first and second holder cases 131 and 132 may have asymmetric shapes to each other. By forming the first and second holder cases 131 and 132 on left and right sides of the frame case 150 in symmetric shapes, the incorrect assembling may be prevented. (It is to be understood that although the first holder case 131 is depicted as being on a right side of the frame case 150 and the second holder case 132 is depicted as being on a left side of the frame case 150, the relative position of the first and second holder case 131 and 132 may be reversed, along with corresponding features of the first assembly region A2 and the second assembly region A2 described below.)

The different shapes of the first and second holder cases 131 and 132 may provide a misalignment prevention structure. In detail, the first holder case 131 may have a protrusion 131a protruding laterally, and the second holder case 132 may have a planar surface without a protrusion.

A protrusion housing portion 152a that fits the protrusion 131a in shape may be selectively formed in a first assembly region A1 on which the first holder case 131 is assembled. A coupling interruption portion 159 that interrupts coupling with the protrusion 131a may be formed on a second assembly region A2 on which the second holder case 132 is assembled. Accordingly, the first holder case 131 cannot be assembled on the second assembly region A2.

The holder case 130 may be assembled with respect to the frame case 150. For example, as illustrated in FIG. 5, the holder case 130 may be assembled on the second supporting portion 152 of the frame case 150. The first assembly region A1 and the second assembly region A2 may be designated in the second supporting portion 152 of the frame case 150. The first and second assembly regions A1 and A2 respectively denote where the first and second holder cases 131 and 132 are assembled. A misalignment prevention structure is formed in the first and second assembly regions A1 and A2. That is, the protrusion housing portion 152a for housing the protrusion 131a of the first holder case 131 may be formed in the first assembly region A1, and the coupling interruption portion 159 may be formed corresponding to the protrusion 131a in the second assembly region A2 to prevent coupling with the first holder case 131.

For example, as denoted by a reference numeral 1 in FIG. 5, the protrusion 131a of the first holder case 131 may fit the protrusion housing portion 152a in the first assembly region A1 in shape, thereby allowing coupling. However, as denoted by a reference numeral 2 in FIG. 5, the protrusion 131a may not be coupled to the coupling interruption portion 159 in the second assembly region A2 due to the structural interruption.

The first and second holder cases 131 and 132 may additionally include another misalignment prevention structure, in addition to the protrusion 131a of the first holder case 131. This additional misalignment prevention structure will now be described in detail.

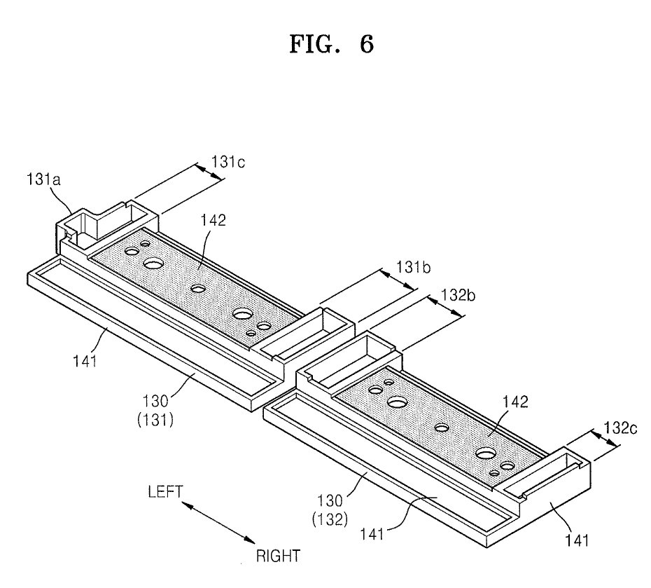

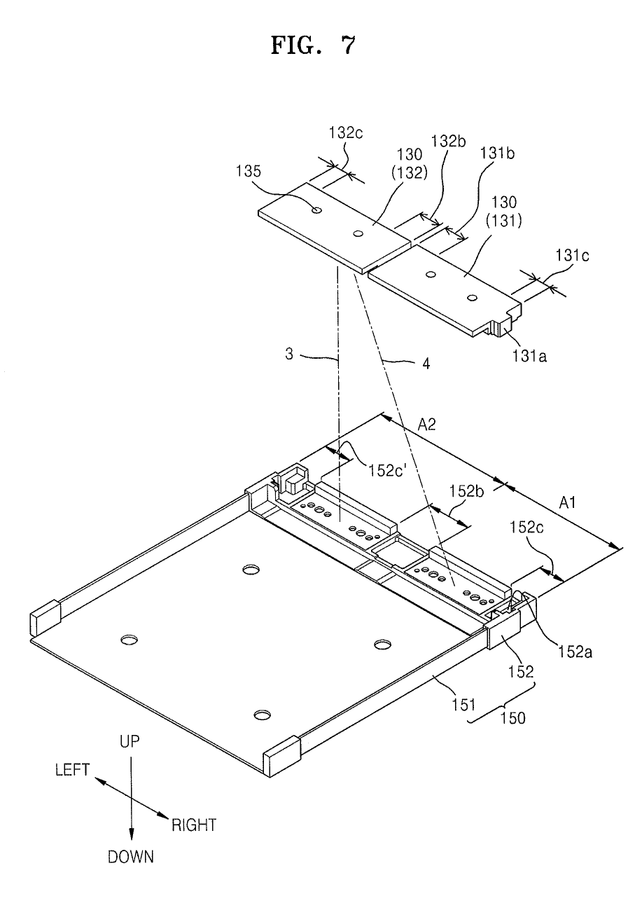

FIGS. 6 and 7 are views to explain the additional misalignment prevention structure. Referring to FIG. 6, the first and second holder cases 131 and 132 may have relatively wide protrusions 131b and 132b in an inner side of the second supporting portion 152, and relatively narrow protrusions 131c and 132c in an outer side of the second supporting portion 152. The wide protrusions 131b and 132b and the narrow protrusions 131c and 132c formed in the first and second holder cases 131 and 132 may provide a misalignment prevention structure for preventing incorrect assembling of the holder case 130.

Referring to FIG. 7, a wide housing portion 152b that fits the wide protrusions 131b and 132b in shape and narrow housing portions 152c and 152c′ that fit the narrow protrusions 131c and 132c in shape may be provided in the first and second assembly regions A1 and A2 on which the first and second holder cases 131 and 132 are assembled. For example, as denoted by a reference numeral 4 in FIG. 7, when the second holder case 132 is incorrectly assembled on the first assembly region A1, the wide protrusion 132b of the second holder case 132 is forced with respect to the narrow housing portion 152c of the first assembly region A1 and does not fit the narrow housing portion 152c.

In detail, the wide housing portion 152b for housing the wide protrusions 131b and 132b of the first and second holder cases 131 and 132, and the narrow housing portions 152c and 152c′ for housing the narrow protrusions 131c and 132c of the first and second holder cases 131 and 132, may be formed in the first and second assembly regions A1 and A2. For example, the wide housing portion 152b may be formed in the inner region of the second supporting portion 152, and the narrow housing portions 152c and 152c′ may be formed in the outer region of the second supporting portion 152.

For example, as denoted by a reference numeral 3 in FIG. 7, when the second holder case 132 is assembled with respect to the second assembly region A2, the wide protrusion 132b and the narrow protrusion 132c of the second holder case 132 respectively fit the wide housing portion 152b and the narrow housing portion 152c′ in the second assembly region A2 in shape, thereby allowing coupling. However, as denoted by the reference numeral 4 in FIG. 7, if the second holder case 132 is incorrectly assembled with respect to the first assembly region A1, the wide protrusion 132b and the narrow protrusion 132c of the second holder case 132 may be respectively located corresponding to the narrow housing portion 152b and the wide housing portion 152c of the first assembly region A1 and forced to incorrect locations. Thus, the second holder case 132 cannot be coupled to the first assembly region A1. The wide protrusion 132b of the second holder case 132 is forced with respect to the narrow housing portion 152c of the first assembly region A1, and the wide protrusion 132b and the narrow housing portion 152c may not correctly fit each other due to their different widths.

Likewise, if the first holder case 131 is incorrectly assembled with respect to the second assembly region A2, the wide protrusion 131b and the narrow protrusion 131c of the first holder case 131 may be incorrectly forced with respect to the narrow housing portion 152c′ and the wide housing portion 152b of the second assembly region A2. Thus, the first holder case 131 may not be coupled to the second assembly region A2. In this regard, the wide protrusion 131b of the first holder case 131 is forced with respect to the narrow housing portion 152c′ of the second assembly region A2, and the wide protrusion 131b and the narrow housing portion 152c′ may not correctly fit each other.

The wide housing portion 152b and the narrow housing portions 152c and 152c′ may be respectively formed in the inner side and outer side of the second supporting portion 152, and the wide housing portion 152b houses the wide protrusions 131b and 132b of the first and second holder cases 131 and 132. That is, the respective wide protrusions 131b and 132b may be placed inside the wide housing portion 152b together. For example, the wide housing portion 152b may be divided into two portions and the wide protrusions 131b and 132b of the first and second holder cases 131 and 132 may be respectively placed in the divided portions.

Meanwhile, the narrow housing portions 152c and 152c′ may be respectively formed at left and right edges of the second supporting portion 152, and respectively house the narrow protrusion 131c of the first holder case 131 and the narrow protrusion 132c of the second holder case 132.

By way of summation and review, an embodiment may provide a misalignment prevention structure for the prevention of incorrect assembling, that is, the prevention of a lateral misalignment of a battery pack on a tray when a plurality of battery packs are mounted on the tray.

Another embodiment may provide a holder case for enhancing electrical binding of a lead tap that forms a path for charge and discharge currents.

Another embodiment may provide a misalignment prevention structure for preventing incorrect assembling of a pair of holder cases in a battery pack.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A battery pack comprising:
a battery unit including a battery cell, and a lead tap extending from the battery cell;
a frame case that supports the battery unit, the frame case including a first supporting portion for supporting the battery cell and a second supporting portion for supporting the lead tap; and
a holder case on the second supporting portion with the lead tap interposed between the holder case and the second supporting portion.

2. The battery pack as claimed in claim 1, wherein the lead tap includes a pair of first and second lead taps, and
the holder case includes a pair of first and second holder cases that respectively overlap the first and second lead taps on first and second sides of the second supporting portion.

3. The battery pack as claimed in claim 2, wherein the first and second holder cases include a misalignment prevention structure for preventing incorrect assembling of one of the first and second holder cases into an assembly position of another one of the first and second holder cases.

4. The battery pack as claimed in claim 3, wherein a shape of the first holder case is asymmetric to a shape of the second holder case such that the first holder case is prevented from being assembled in an assembly position of the second holder case.

5. The battery pack as claimed in claim 3, wherein the first holder case has a protrusion such that the first holder case is prevented from being assembled in an assembly position of the second holder case.

6. The battery pack as claimed in claim 5, wherein the second supporting portion includes first and second assembly regions having shapes that respectively correctly fit the first and second holder cases.

7. The battery pack as claimed in claim 6, wherein the first assembly region includes a protrusion housing portion for housing the protrusion of the first holder case.

8. The battery pack as claimed in claim 6, wherein the second assembly region includes a coupling interruption portion for preventing coupling with the protrusion of the first holder case.

9. The battery pack as claimed in claim 1, wherein the first supporting portion includes:
a main body for supporting a main surface of the battery cell; and
first and second ribs that are bent from the main body at opposite lateral sides of the main body and extend in parallel along side surfaces of the battery cell.

10. The battery pack as claimed in claim 9, wherein first and second spacers are respectively located at ends of the first and second ribs in asymmetric positions in an extension direction of the first and second ribs.

11. The battery pack as claimed in claim 1, wherein:
the holder case includes a pair of first and second holder cases, and
an inner edge of each of the first and second holder cases includes a wide protrusion,
an outer edge of each of the first and second holder cases includes a narrow protrusion,
the inner edges are adjacent to each other,
the outer edges are located away from each other, and
the wide and narrow protrusions have different widths.

12. The battery pack as claimed in claim 11, wherein the second supporting portion includes a wide housing portion that receives the wide protrusions of the first and second holder cases, and narrow housing portions that respectively receive the narrow protrusions of the first and second holder cases.

13. The battery pack as claimed in claim 1, wherein:
a terminal member is coupled to the second supporting portion as one piece, and
the lead tap is disposed on the terminal member.

14. A battery pack comprising:
a battery unit including a battery cell and first and second lead taps extending from the battery cell;
a frame case that supports the battery unit and includes a first supporting portion for supporting the battery cell and a second supporting portion for supporting the first and second lead taps; and
first and second holder cases on the second supporting portion with the first and second lead taps interposed between the first and second holder cases, respectively, and the second supporting portion,
wherein a shape of the first holder case is asymmetric to a shape of the second holder case.

15. The battery pack as claimed in claim 14, wherein the first holder case has a protrusion protruding from a side surface thereof.

16. The battery pack as claimed in claim 15, wherein the second supporting portion includes first and second assembly regions having shapes that respectively fit the first and second holder cases, and
a protrusion housing portion for housing the protrusion is formed in the first assembly region.

17. The battery pack as claimed in claim 16, wherein the second assembly region includes a coupling interruption portion for interrupting coupling with the protrusion.

18. The battery pack as claimed in claim 14, wherein:
a terminal member is coupled to the second supporting portion as one piece, and
the first and second lead taps are disposed on the terminal member.

19. The battery pack as claimed in claim 14, wherein the first supporting portion includes:
a main body for supporting a main surface of the battery cell; and
first and second ribs that are bent from the main body at opposite lateral sides of the main body and extend in parallel along side surfaces of the battery cell.

20. The battery pack as claimed in claim 19, wherein first and second spacers are respectively located at ends of the first and second ribs in asymmetric positions in an extension direction of the first and second ribs.
